(19) United States
(12) Patent Application Publication
(10) Pub. No.: US 2012/0247073 A1
(43) Pub. Date: Oct. 4, 2012

(54) RECYCLABLE PARTICULATE FILTER

(75) Inventors: Isabelle Louis-Rose, Draveil (FR); Najat Moral-Mouaddib, Saint Michel sur orge (FR); Andres-Felipe Villegas, Paris (FR)

(73) Assignee: RENAULT s.a.s., Boulogne-Billancourt (FR)

(21) Appl. No.: 13/514,834

(22) PCT Filed: Nov. 10, 2010
(86) PCT No.: PCT/FR2010/052417

§ 371 Date: Jun. 8, 2012

(30) Foreign Application Priority Data
Dec. 15, 2009 (FR) 0958971

(51) Int. Cl. B01D 29/72; B01D 29/11; B01D 29/01

(52) U.S. Cl. 55/304; 55/301

(57) ABSTRACT

An exhaust gas filter for a vehicle having a heat engine that includes, inside a filter body, at least one soot-filtering pleated medium, and a mechanism for unsealing the medium.

The invention relates to the post-treatment of soot particles generated by an internal combustion engine in a vehicle exhaust line.

The strengthening of regulations on polluting emissions from internal combustion vehicles is resulting, especially for vehicles operating with what is called a “lean mixture”, in the installation of such post-treatments.

Thus, a number of post-treatment devices are known that consist of filters which accumulate therewithin the particles to be eliminated. These filters contain a filter media made of ceramic and consisting of channels in which the soot is allowed to accumulate. They are periodically cleaned throughout their use, while the vehicle is running, by a cleaning process called regeneration, which consists in injecting, upstream of the filter, fuel for burning off the accumulated soot particles.

These known particulate filters use a filter media made of a heavy and expensive material.

Moreover, their reliability is limited, on the one hand, by the soot combustion, which is an extremely exothermic process liable to crack the ceramic, and, on the other hand, by the accumulation of soot combustion ash, which gradually blocks off the channels of the filter media.

Finally, using the injection of fuel to burn off the soot increases the fuel consumption of the vehicle, increases the discharge of carbon dioxide (COz) that results from burning off the soot, and it shortens the engine oil change intervals owing to greater dilution of the oil with fuel.

The object of the invention is to reduce the weight and the cost of known particulate filters and to improve the reliability thereof. The aim is also to reduce the fuel consumption, to reduce the amount of COz discharged by the vehicle and to lengthen the oil change intervals thereof. To do so, the invention provides a recyclable filter media which can be unclogged by the vibrations of the vehicle that are transmitted to the filter and by gravity, without having to inject fuel or to burn off the soot. The aim of the invention is also to provide a volume for storing the soot, away from the filter media, and means for compacting the soot, in order to remove it.

One particular form of the surface of the filter media, for example of “egg box” shape, makes it possible to facilitate the unclogging operation.

According to a first embodiment, the filter media takes the form of a flat panel, and according to a second embodiment it takes the form of a tube. Optionally, the media may be pleated.

In these various cases, the soot may be compacted by the action of a movable element, for example a piston, or by the pressure of the exhaust gas.

Other features and advantages of the present invention will become clearly apparent on reading the following description of several nonlimiting embodiments thereof, with reference to the appended drawings in which:

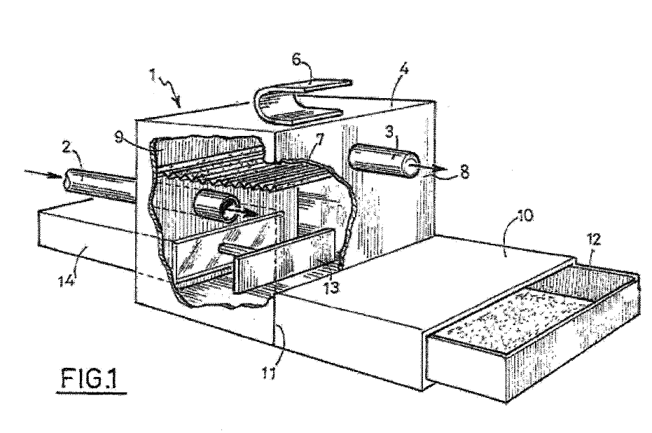

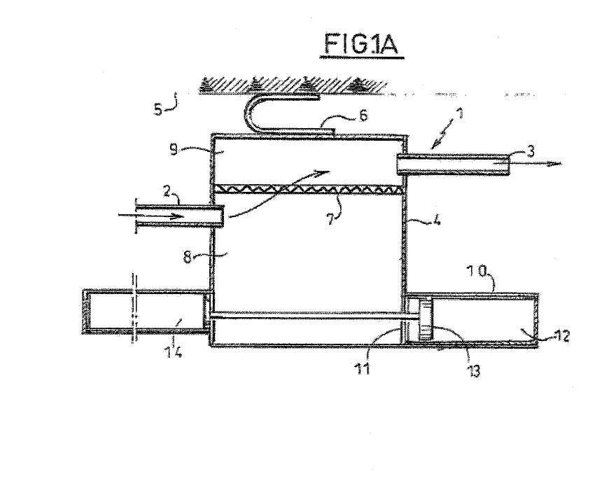

FIGS. 1 and 1A show respectively a perspective view and a cross-sectional view of a filter equipped with a filter media in the form of a flat panel and with a soot-compacting piston;

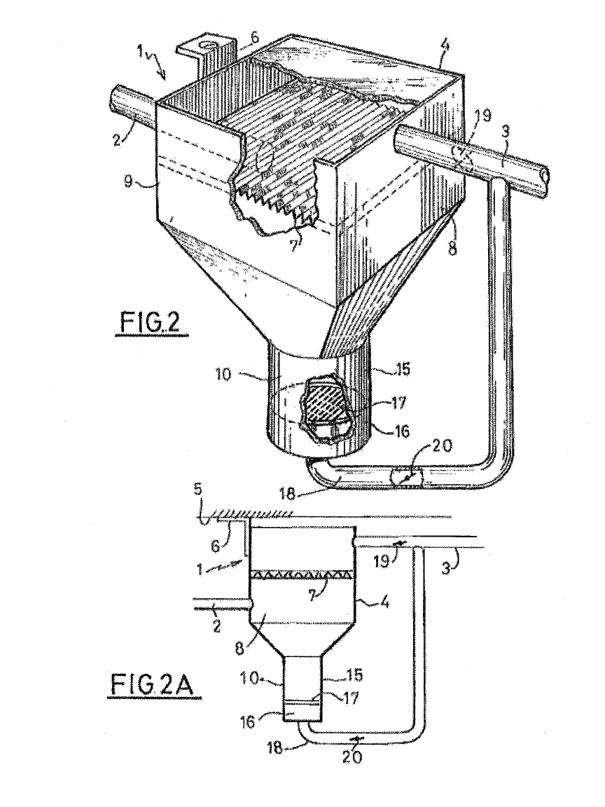

FIGS. 2 and 2A show respectively a perspective view and a cross-sectional view of an alternative filter with a system for compacting the soot by gas pressure;

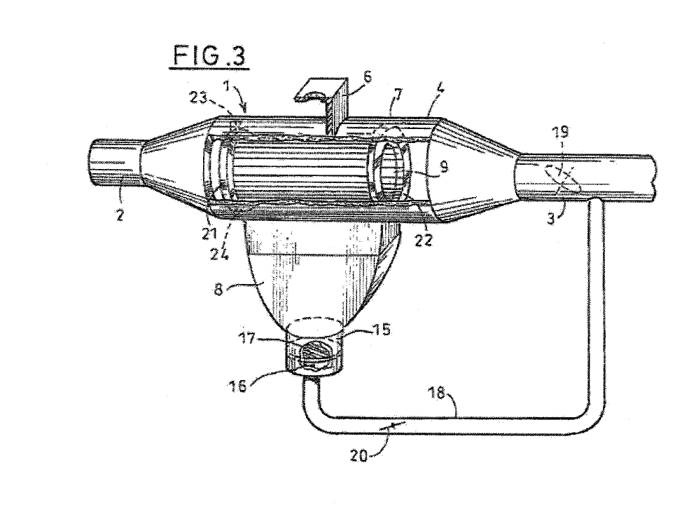

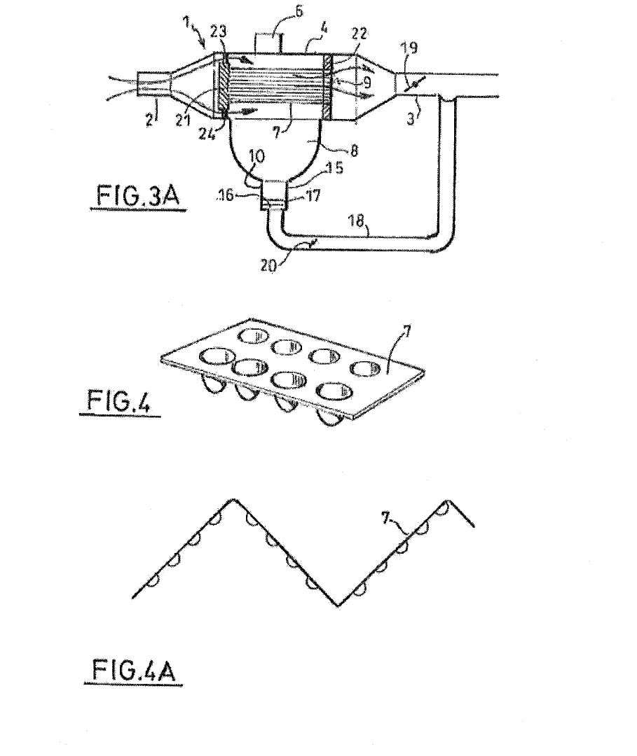

FIGS. 3 and 3A show respectively a perspective view and a cross-sectional view of an alternative filter in tabular form; and

FIGS. 4 and 4A illustrate nonlimitingly the structure of the filter media.

Referring to FIGS. 1 and 1A, the particulate filter 1 comprises, between an exhaust gas inlet pipe 2 and an exhaust gas outlet pipe 3, a filter body 4 which is fixed, for example welded, to said pipes.

In its upper external part, the body 4 is fixed to the bodywork 5 (visible in FIG. 1A) of the vehicle by at least one connecting tab 6 enabling the vibrations coming from the vehicle when running to be transmitted to the filter 1.

The filter body 4 contains, in its upper part, a filter media 7 that takes the form of a substantially horizontal panel. This filter media 7 is removably fixed, for example clip-fastened, to the body 4, which also provides the function of supporting the filter media 7.

The filter media 7 is produced by means of a thickness of optionally pleated material. It separates the filter body 4 into two parts: beneath the filter media, a dirty chamber 8 into which the inlet pipe 2 introduces the gases to be filtered and, above the filter media, a clean chamber 9 from which the filtered gases emerge toward the outlet pipe 3 after having passed through the filter media 7.

While the vehicle is running, the particulate filter 1 has the following operating mode: the soot present in the exhaust gas upon its arrival in the dirty chamber 8 is retained by the filter media 7 and collects on the underside of the panel. Owing to the vibrations of the vehicle and gravity, the soot particles are stripped from the filter media 7 and collected in the bottom of the dirty chamber 8. In this way, the filter media 7 becomes unclogged.

The filter body 4 also contains, in its lower part, means for compacting and storing the soot before it is removed therefrom.

The body is extended by a storage volume 10, for example a parallelepipedal cassette which is fixed, for example welded, to the filter body 4.

The storage volume 10 communicates with the dirty chamber 8 via an opening 11 and may contain a removable drawer 12 (along the right-hand extension of the filter body 4 in FIG. 1A) which slides in the manner of a matchbox and may be removed from the storage volume (10) via the right.

When the vehicle is stopped, the filter 1 has the following operating mode: the bottom of the dirty chamber 8 is swept horizontally from the left to right by a movable element 13, for example a piston mQ by an electric actuator 14. The soot accumulated in the bottom of the dirty chamber 8 while the vehicle is running is pushed into the storage volume 10 through the opening 11. The piston is then brought back into the left-hand position.

The movements of the piston may be repeated each time the vehicle is stopped.

It is also possible to choose to initiate the movements of the piston in a different manner, for example upon restarting the vehicle or periodically when running.

The soot is gradually compacted in the bottom of the drawer 12. When a certain saturation threshold is reached, the storage volume 10 is emptied of its soot, by extracting the removable drawer 12 via the right. At that occasion, the filter media 7 may be replaced with a fresh media.

FIGS. 2 and 2A show a second embodiment of the invention. This embodiment differs from the previous one in that the soot is compacted by the pressure difference of the exhaust gas.

The particulate filter 1 comprises, beneath the dirty chamber 8, a compacting unit 15. This unit 15 is removably mounted, for example screwed, beneath the filter body 4. In its lower part it has a compression chamber 16 which is separated from the dirty chamber 8 by a rigid compacting filter membrane 17, for example a filter media resting on a metal grid. The unit 15 also includes in its upper part a storage volume 10.

The compression chamber 16 is connected to the exhaust gas outlet pipe 3 via a secondary pipe 18.

The pipe 18 opens into the outlet pipe 3 downstream of a main valve 19 mounted in the outlet pipe 3. The pipe 18 is equipped with a secondary valve 20. Depending on the position of the valves, the filter 1 has two different operating modes:
in “filtration” mode, the main valve 19 is open and the secondary valve 20 is closed. The exhaust 302 passes through the filter media 7, the soot particles accumulate therein and drop to the bottom of the dirty chamber 8;
in “compacting” mode, the main valve 19 is closed and the secondary valve 20 is open. The exhaust gas then passes through the compacting filter membrane on which the soot is deposited. Thanks to the pressure difference between the dirty chamber 8 and the compression chamber 16, the soot is compacted on the surface of the membrane 17. When a certain level of saturation of the storage volume 10 is reached, the unit 15 may be removed and emptied.

FIGS. 3 and 3A show as a variant a filter media 7 having a tabular shape, for example a cylindrical shape.

This tabular media 7 includes at its ends two fastening rings 21 and 22.

The first ring 21, on the left in the figures, closes off the inlet of the tube. Its diameter is smaller than the cross section of the body 4 in which it is housed. The ring is fixed on its periphery by at least two lugs 23 and 24. The exhaust gas can therefore pass through the section of the body 4 left free by the ring 21 and is directed onto the external lateral walls of the filter media 7.

The second ring 22, on the right in the figures, is in the form of a flat ring. It is open in its central part in order to allow the filtered exhaust gas to be discharged via the inside of the tube. Its outer edge matches the shape of the body 4 so as to close off the section of the body around the tube. This closure forces the incoming (unfiltered) gas to pass through the media 7 and prevents any filtered gas flowing back upstream.

In other words, the tubular filter media 7, in combination with the two rings 23 and 24, separates the filter body 4 into two separate volumes, namely a dirty chamber 8 and a clean chamber 9, as in the first embodiment.

FIGS. 4 and 4A illustrate a nonlimiting example of the surface of the filter media 7, for example in the form of an “egg box”, which facilitates the unclogging of the media 7. This shape perfectly integrates with a media 7 having a pleated structure, as indicated in FIG. AA.

To summarize, the particulate filter 1 according to the invention has at least one gas filter media 7 for filtering the exhaust gas and collecting the soot on the surface thereof. Moreover, it includes unclogging and storage means located away from the media (7).

1-10. (canceled)

11. A filter for exhaust gas of a vehicle with an internal combustion engine, comprising:
inside a filter body, at least one pleated filter media for filtering soot; and
means for unclogging the media.

12. The filter as claimed in claim 11, wherein the filter media is a substantially horizontal panel removably mounted on the body.

13. The filter as claimed in claim 11, wherein the filter media has a form of a tube removably mounted on the body.

14. The filter as claimed in claim 11, wherein the filter media is unclogged through action of vibrations of the body of the vehicle when it is running and by gravity.

15. The filter as claimed in claim 11, further comprising a storage volume away from the filter media.

16. The filter as claimed in claim 11, further comprising means for compacting the soot.

17. The filter as claimed in claim 16, wherein the compacting of the soot is carried out by a movable element.

18. The filter as claimed in claim 16, wherein the compacting of the soot is carried out by a pressure difference.

19. The filter as claimed in claim 16, wherein a soot storage volume is removable.

20. The filter as claimed in claim 11, wherein a surface of the filter media is in a form of an egg box.
